(19) United States
(12) Patent Application Publication
(10) Pub. No.: US 2026/0061374 A1
(43) Pub. Date: Mar. 5, 2026

(54) DEVICE FOR DISSOLVING CELLULOSE WITH HIGH SPEED AND SOLUBILITY

(71) Applicant: Southwest Forestry University, Kunming (CN)

(72) Inventors: Yushan YANG, Kunming (CN); Chenyang FAN, Kunming (CN); Kangkang ZHANG, Kunming (CN); Jian QIU, Kunming (CN); Jun LI, Kunming (CN); Lin LIU, Kunming (CN); Xian WANG, Kunming (CN); Chunwang YANG, Kunming (CN); Huajie SHEN, Kunming (CN)

(73) Assignee: Southwest Forestry University, Kunming, YN (CN)

(21) Appl. No.: 19/379,636

(22) Filed: Nov. 4, 2025

(30) Foreign Application Priority Data
Dec. 19, 2024 (CN) 202411881616.4

(51) Int. Cl. B01F 21/10; B01F 27/2124; B01F 27/95; B01F 35/30; B01F 35/31; B01F 35/32; B01F 35/33; B01F 35/43; B01F 35/71; C08B 1/00

(52) U.S. Cl. CPC B01F 21/10; B01F 27/2124; B01F 27/95; B01F 35/31; B01F 35/3204; B01F 35/33; B01F 35/43; B01F 35/7174; C08B 1/003; B01F 2035/352

(57) ABSTRACT

The present disclosure belongs to the field of cellulose dissolution technology, particularly relates to a device for dissolving cellulose with high speed and solubility. The device comprises a baseplate and a dissolving canister arranged on surface of the baseplate, bottom surface of the dissolving canister is fixedly connected with a supporting column, and surface of the dissolving canister is installed with a liquid-discharge pipe. The device further comprises a stirring assembly arranged above the dissolving canister, and the stirring assembly comprises an L-shaped installing block arranged above the dissolving canister. Surface of the L-shaped installing block is fixedly connected with a connection block, and surface of the connection block is fixedly connected with a dispensing canister. Lower end of the dispensing canister is rotatably connected with a first synchronizing wheel, one side of the first synchronizing wheel away from the dispensing canister is fixedly connected with a rotation member.

### CROSS-REFERENCE TO RELATED APPLICATION

This application claims priority to Chinese Patent Application No. 202411881616.4, filed on Dec. 19, 2024, which is hereby incorporated by reference in its entirety.

### TECHNICAL FIELD

The present disclosure belongs to the field of cellulose dissolution technology, and specifically relates to a device for dissolving cellulose with high speed and solubility.

### BACKGROUND ART

Cellulose is a polysaccharide substance with high crystallinity and stability. Therefore, in the dissolution process of cellulose, corresponding dissolving agents are often added for dissolution. During this process, a continuous addition of dissolving agents while stirring is often used to accelerate dissolution of the cellulose and ensure sufficient mixing of dissolving agents. However, existing device for dissolving cellulose cannot add an appropriate amount of dissolving agents according to amount of the cellulose in a stirring canister.

Therefore, a device for dissolving cellulose with high speed and solubility is designed to solve the above problems.

### SUMMARY

To address the problems raised in the background art mentioned above, the present disclosure provides a device for dissolving cellulose with high speed and solubility, which can fully stir the cellulose and accelerate dissolution of the cellulose during the dissolution process of the cellulose. The height and position of the stirring member can be adjusted according to required amount of the cellulose to be dissolved, and amount of continuous added dissolving agents can be adjusted to make the reaction more complete.

To achieve the above objectives, the present disclosure provides following technical solution: a device for dissolving cellulose with high speed and solubility, which includes a baseplate and a dissolving canister arranged on surface of the baseplate, bottom surface of the dissolving canister is fixedly connected to a supporting column, and surface of the dissolving canister is installed with a liquid-discharge pipe;
the device further includes a stirring assembly arranged above the dissolving canister, the stirring assembly includes an L-shaped installing block arranged above the dissolving canister, and surface of the L-shaped installing block is fixedly connected with a connection block, and surface of the connection block is fixedly connected with a dispensing canister, lower end of the dispensing canister is rotatably connected with a first synchronizing wheel, one side of the first synchronizing wheel away from the dispensing canister is fixedly connected with a rotation member, lower end of the rotation member is rotatably connected with a connection rod, lower end of the connection rod is fixedly connected with an electric telescopic rod, end of an extension shaft of the electric telescopic rod is fixedly connected with a stirring rod, and lower end of the stirring rod is fixedly connected with a stirring member.

In some embodiments, in the device for dissolving cellulose with high speed and solubility, the surface of the connection block is installed with a first outputting electric machine, output shaft of the first outputting electric machine passes through the positioning canister and is fixedly connected to the first synchronizing wheel.

In some embodiments, in the device for dissolving cellulose with high speed and solubility, two position-limiting plates are symmetrically arranged below the connection block, the connection rod passes through rings provided on surface of each of the two position-limiting plates, two curved surface blocks are symmetrically and fixedly connected to a position of the connection rod between the two position-limiting plates, and each of the two curved surface blocks is matched with one of the rings of the two position-limiting plates.

In some embodiments, in the device for dissolving cellulose with high speed and solubility, surface of each of the two position-limiting plates is fixedly connected with a connection frame, surface of the connection frame is rotatably connected with a transmission rod, a transmission gear is fixedly connected to a position of the transmission rod between two connection frames, an outputting gear is arranged between the two curved surface blocks, the outputting gear is fixedly connected on surface of the connection rod, the transmission gear is meshed with the outputting gear, upper end of the transmission rod is fixedly connected with a second synchronizing wheel, and the first synchronizing wheel and the second synchronizing wheel are connected via a synchronizing belt.

In some embodiments, in the device for dissolving cellulose with high speed and solubility, the device further includes a movement assembly arranged on the surface of the baseplate, the movement assembly includes a vertical plate fixedly connected on the surface of the baseplate, upper end of the vertical plate is fixedly connected with a movement frame, and surface of the movement frame is provided with a movement groove; the L-shaped installing block is connected to the movement frame in a sliding manner via the movement groove, the upper surface of the movement frame is installed with a second outputting electric machine, output end of the second outputting electric machine is fixedly connected with a lead screw, the lead screw passes through the movement frame and is rotatably connected to the movement frame, the lead screw is connected to the L-shaped installing block via threads, inner side of the movement groove is provided with a guide rod, and the guide rod is connected to the L-shaped installing block via a sliding manner.

In some embodiments, in the device for dissolving cellulose with high speed and solubility, the surface of the L-shaped installing block is fixedly connected with a block for resisting pressure, upper surface of the movement frame is fixedly connected with a dispensing subassembly, and the surface of the movement frame is fixedly connected with a fixing plate.

In some embodiments, in the device for dissolving cellulose with high speed and solubility, the device further includes a feed assembly arranged on the surface of the movement frame, wherein the feed assembly includes three slots provided on the surface of the movement frame, the three slots each are connected with the movement groove, and inner side of each of the three slots is provided with a rod, the rod is connected to the movement frame in a sliding manner via the slot, one end of the rod is fixedly connected with a contact for resisting pressure adapted to the block for resisting pressure, surface of the rod is wound with a first spring, and each of two ends of the first spring is fixedly connected between the contact for resisting pressure and the movement frame.

In some embodiments, in the device for dissolving cellulose with high speed and solubility, one end of the rod away from the contact for resisting pressure is fixedly connected with a bearing plate, surface of the bearing plate is provided with three fixing rings, the bearing plate is connected with a push rod via the fixing rings, inner side of only one of the three fixing rings on surface of a same bearing plate is installed with the push rod, and position of the push rod connected on surface of one bearing plate of the three bearing plates is offset from other two positions of the push rod corresponding to other two bearing plate of the three bearing plates.

In some embodiments, in the device for dissolving cellulose with high speed and solubility, interior of the dispensing subassembly is installed with a discharge barrel, lower surface of the discharge barrel is connected with a discharge pipe, outlet of lower end of the discharge pipe is connected with a feed pipe, a fixing column is arranged between the feed pipe and the fixing plate, one end of the fixing column is fixedly connected to the fixing plate, and another end of the fixing column is fixedly connected to the feed pipe.

In some embodiments, in the device for dissolving cellulose with high speed and solubility, inner side of the discharge pipe is provided with three baiting grooves and one active groove, the push rod passes through surface of the discharge pipe and is fixedly connected to a rubber block inside the discharge pipe, the surface of the discharge pipe is provided with a connected groove adapted to the rubber block, the rubber block is connected to the discharge pipe in a sliding manner via the connected groove, inner side of the active groove is provided with a positioning column, surface of the positioning column is connected with a push ring in a sliding manner, and the surface of the positioning column is wound with a second spring, one end of the second spring is fixedly connected to the push ring, and another end of the second spring is fixedly connected to the discharge pipe, and surface of the rubber block is provided with a positioning groove adapted to the positioning column.

Compared with the existing technology, beneficial effects of the present disclosure are as follows.

1. The circumferential stirring generated by rotation of the connection rod driven by the rotation member is coordinated with the circumferential stirring brought by an adjustable height of the electric telescopic rod. The circumferential stirring forms a vortex flow in the horizontal direction of the solution, pushing the cellulose to perform a circular motion in the canister. The circumferential stirring promotes the cellulose to continuously flip up and down in the vertical direction. This multi-dimensional stirring manner ensures that the cellulose in various positions of the dissolving canister can be fully mixed and subjected to shear force, avoiding the situation where some cellulose dissolves slowly or even not due to dead angles for mixing, making the entire dissolution process more uniform and efficient. During the movement of the connection rod, center position of the outputting gear remains unchanged via mutual cooperation between the curved surface blocks and the position-limiting plate, such that the outputting gear can be always meshed with the transmission gear.

The end of the extension shaft of the electric telescopic rod is connected to the stirring rod. This design allows for automatic adjustment of the stirring position according to real-time changes in the level of the solution inside the dissolving canister. In the initial stage of dissolution, when the level of the solution is low, the electric telescopic rod can be extended to bring the stirring member close to bottom of the dissolving canister, focusing on strong stirring of the high-concentration cellulose area at the bottom to accelerate the initial dissolution of cellulose. As the dissolution process progresses, the level of the solution rises, and the electric telescopic rod continuously extends and contracts, gradually expanding the stirring range to the entire solution volume, ensuring that cellulose at different depths can continue to be effectively stirred, maintaining high efficiency and uniformity of dissolution.

In the transmission structure below the connection block, the cooperation between the position-limiting plate and the curved surface block ensures the stability of the connection rod during rotation and up and down movement, avoiding displacement or shaking of the connection rod. The precise meshing between the transmission gear and the outputting gear, as well as the reliable connection between the first synchronizing wheel and the second synchronizing wheel via the synchronizing belt, stably transmit power of first outputting electric machine to the stirring assembly, while allowing the stirring rod to rotate while revolving, thereby providing continuous and stable shear force and mixing effect for cellulose, which is conducive to forming a stable dissolution environment and improving the repeatability and reliability of the dissolution effect.

2. The lead screw on the movement frame drives the L-shaped installing block to move along the movement groove, so that the stirring effect of the stirring assembly is no longer limited to a fixed area. On the cross-section of the dissolving canister, the stirring assembly can sequentially stir and treat various portions of the dissolving canister.

Due to the flexible movement of the movable stirring assembly above the dissolving canister, operators can selectively move the stirring assembly to areas with relatively slow cellulose dissolution or high concentration for focused stirring according to real-time monitoring or empirical judgment of the dissolution process.

3. When the L-shaped installing block moves, the contact between the block for resisting pressure and the contact for resisting pressure triggers the rod to drive the push rod arranged on the bearing plate, thereby controlling the opening and closing degree of the rubber block inside the discharge pipe, achieving quantitative feeding of the dissolving agent. During the dissolution process, the precise feeding amount can maintain the relative stability of the amount of dissolving agent added in the dissolving canister.

The positions of the push rods connected to the surfaces of the three bearing plates are staggered. During the feeding process, the push rods at different positions move in sequence. When there is too much cellulose to be dissolved in the dissolving canister, the L-shaped installing block drives the stirring member to move upward, making the mixing more uniform. And as the L-shaped installing block moves upward, the rubber blocks inside the discharge pipe are opened in different portions of the dissolving canister in sequence, thereby increasing the amount of added dissolving agents and making the dissolution more sufficient.

### BRIEF DESCRIPTION OF THE DRAWINGS

The accompanying drawings are used to provide further understanding of the present disclosure and form a part of the specification. The accompanying drawings are used together with the embodiments of the present disclosure to explain the present disclosure and do not constitute limitations on the present disclosure. In the accompanying drawings:

FIG. 1 is a schematic diagram of the overall structure of the present disclosure.

FIG. 2 is a schematic structural diagram of the fixing plate in the present disclosure.

FIG. 3 is a schematic structural diagram of the movement groove in the present disclosure.

FIG. 4 is a schematic structural diagram of the connection rod in the present disclosure.

FIG. 5 is a schematic structural diagram of the transmission rod in the present disclosure.

FIG. 6 is a schematic structural diagram of the block for resisting pressure in the present disclosure.

FIG. 7 is a schematic structural diagram of the rod in the present disclosure.

FIG. 8 is a schematic structural diagram of the positioning groove in the present disclosure.

FIG. 9 is an enlarged view of position A in FIG. 6 of the present disclosure.

Where:
1. baseplate; 11. dissolving canister; 12. supporting column; 13. liquid-discharge pipe;
2. movement assembly; 21. vertical plate; 22. movement frame; 23. fixing plate; 24. movement groove; 25. lead screw; 26. second outputting electric machine; 27. block for resisting pressure; 28. guide rod; 29. dispensing subassembly;
3. stirring assembly; 31. connection rod; 32. rotation member; 33. first outputting electric machine; 34. first synchronizing wheel; 35. electric telescopic rod; 36. stirring rod; 37. stirring member; 38. second synchronizing wheel 2; 39. synchronizing belt; 310. transmission rod; 311. position-limiting plate; 312. connection frame; 313. transmission gear; 314. curved surface block; 315. outputting gear; 316. connection block; 317, L-shaped installing block; 318. dispensing canister;
4. feed assembly; 41. discharge barrel; 42. discharge pipe; 43. feed pipe; 44. fixing column; 45. slot; 46. contact for resisting pressure; 47. rod; 48. first spring; 49. bearing plate; 410. push rod; 411. rubber block; 412. material chute; 413. activity slot; 414. push ring; 415. spring 2; 416. positioning column; 417. positioning groove; 418. fixing ring; and 419. connected groove.

### DETAILED DESCRIPTION OF THE EMBODIMENTS

The technical solutions in the embodiments of the present disclosure will be clearly and completely described below in conjunction with the accompanying drawings in embodiments of the present disclosure. Obviously, the described embodiments are only a part of the embodiments of the present disclosure, not all of them. Based on the embodiments of the present disclosure, all other embodiments obtained by ordinary skilled in the art without creative labor are within the scope of protection of the present disclosure.

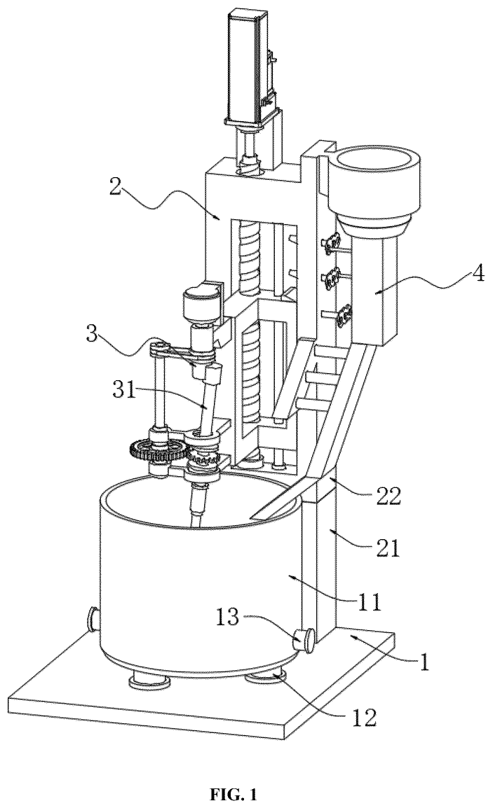

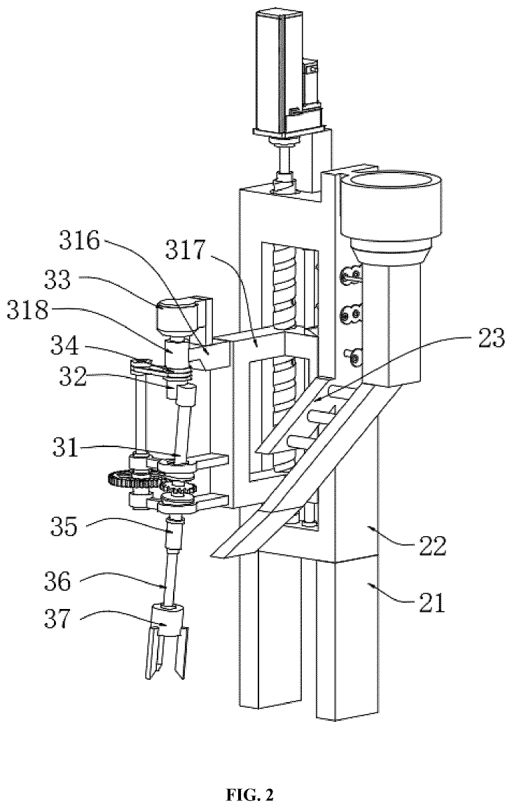

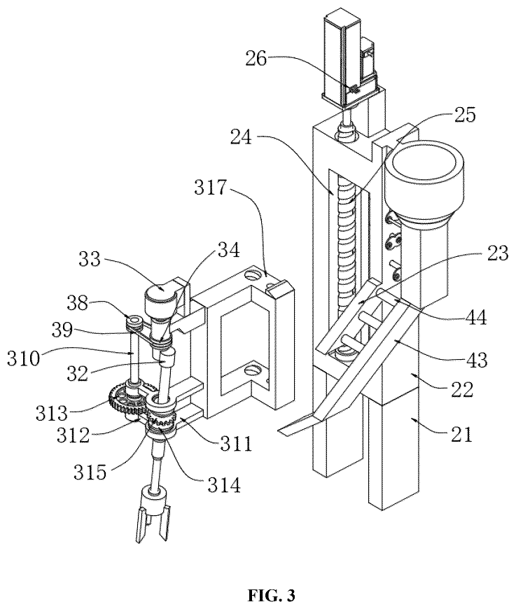

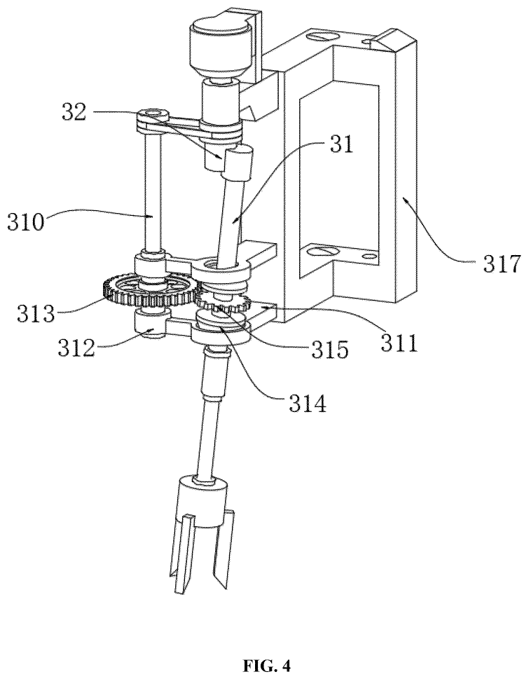

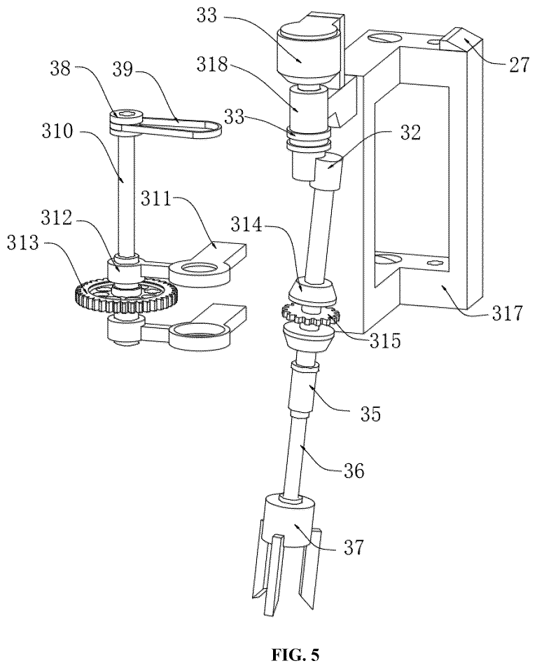

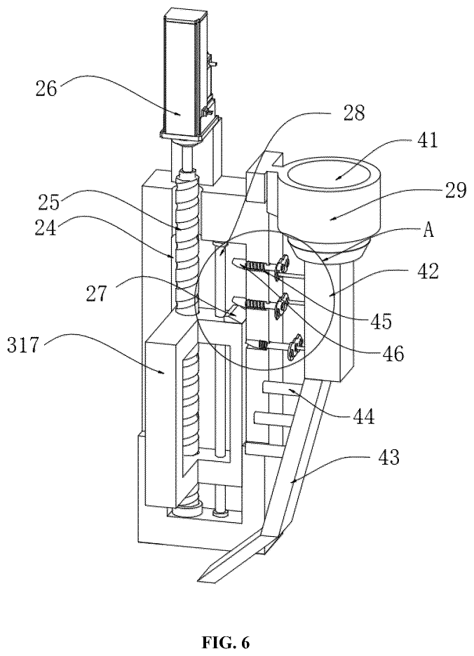

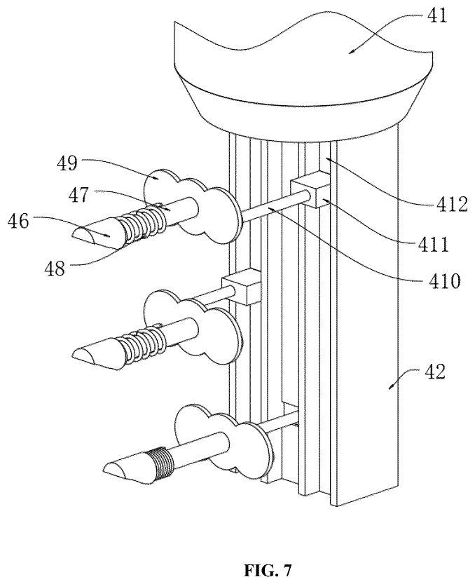

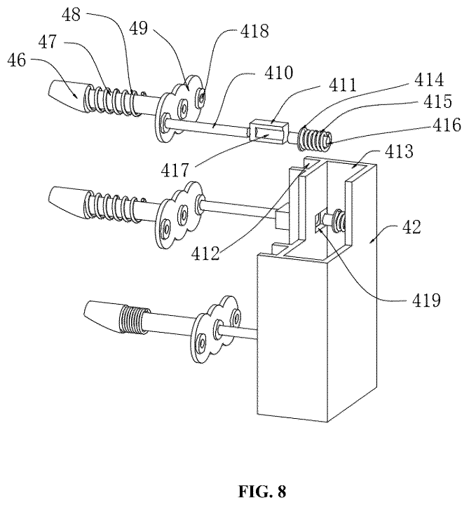

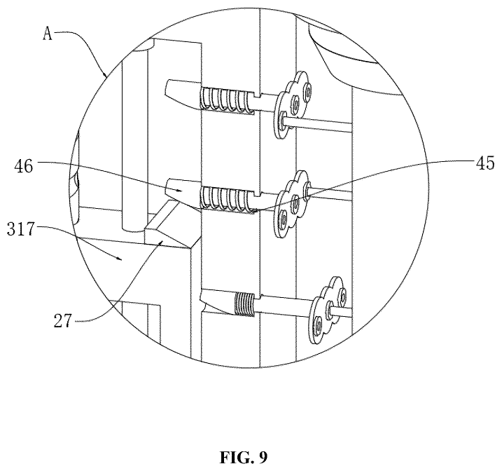

Embodiments: As shown in FIGS. 1-9, the present disclosure provides a technical solution. In the embodiment of the present disclosure, a device for dissolving cellulose with high speed and solubility is provided. The device includes a baseplate 1 and a dissolving canister 11 arranged on surface of the baseplate 1. Bottom surface of the dissolving canister 11 is fixedly connected to a supporting column 12, and surface of the dissolving canister 11 is installed with a liquid-discharge pipe 13.

The device further includes a stirring assembly 3 arranged above the dissolving canister 11. The stirring assembly 3 includes an L-shaped installing block 317 arranged above the dissolving canister 11. Surface of the L-shaped installing block 317 is fixedly connected with a connection block 316, and surface of the connection block 316 is fixedly connected with a dispensing canister 318. Lower end of the dispensing canister 318 is rotatably connected with a first synchronizing wheel 34, and one side of the first synchronizing wheel 34 away from the dispensing canister 318 is fixedly connected with a rotation member 32. Lower end of the rotation member 32 is rotatably connected with a connection rod 31, and lower end of the connection rod 31 is fixedly connected with an electric telescopic rod 35. End of an extension shaft of the electric telescopic rod 35 is fixedly connected with a stirring rod 36, and lower end of the stirring rod 36 is fixedly connected with a stirring member 37.

The surface of the connection block 316 is installed with a first outputting electric machine 33, output shaft of the first outputting electric machine 33 passes through the positioning canister 318 and is fixedly connected to the first synchronizing wheel 34.

Two position-limiting plates 311 are symmetrically arranged below the connection block 316, the connection rod 31 passes through rings provided on surface of each of the two position-limiting plates 311, two curved surface blocks 314 are symmetrically and fixedly connected to a position of the connection rod 31 between the two position-limiting plates 311, and each of the two curved surface blocks 314 is matched with one of the rings of the two position-limiting plates 311.

Surface of each of the two position-limiting plates 311 is fixedly connected with a connection frame 312, surface of the connection frame 312 is rotatably connected with a transmission rod 310, a transmission gear 313 is fixedly connected to a position of the transmission rod 310 between two connection frames 312, an outputting gear 315 is arranged between the two curved surface blocks 314, the outputting gear 315 is fixedly connected on surface of the connection rod 31, the transmission gear 313 is meshed with the outputting gear 315, upper end of the transmission rod 310 is fixedly connected with a second synchronizing wheel 38, and the first synchronizing wheel 34 and the second synchronizing wheel 38 are connected via a synchronizing belt 39.

The device further includes a movement assembly 2 arranged on the surface of the baseplate 1. The movement assembly 2 includes a vertical plate 21 fixedly connected on the surface of the baseplate 1. Upper end of the vertical plate 21 is fixedly connected with a movement frame 22, and surface of the movement frame 22 is provided with a movement groove 24. The L-shaped installing block 317 is connected to the movement frame 22 in a sliding manner via the movement groove 24, the upper surface of the movement frame 22 is installed with a second outputting electric machine 26, output end of the second outputting electric machine 26 is fixedly connected with a lead screw 25. The lead screw 25 passes through the movement frame 22 and is rotatably connected to the movement frame 22. The lead screw 25 is connected to the L-shaped installing block 317 via threads. Inner side of the movement groove 24 is provided with a guide rod 28, and the guide rod 28 is connected to the L-shaped installing block 317 via a sliding manner.

The surface of the L-shaped installing block 317 is fixedly connected with a block for resisting pressure 27, upper surface of the movement frame 22 is fixedly connected with a dispensing subassembly 29, and the surface of the movement frame 22 is fixedly connected with a fixing plate 23.

The device further includes a feed assembly 4 arranged on the surface of the movement frame 22. The feed assembly 4 includes three slots 45 provided on the surface of the movement frame 22, the three slots 45 each are connected with the movement groove 24, and inner side of each of the three slots 45 is provided with a rod 47. The rod 47 is connected to the movement frame 22 in a sliding manner via the slot 45. One end of the rod 47 is fixedly connected with a contact for resisting pressure 46 adapted to the block for resisting pressure 27. Surface of the rod 47 is wound with a first spring 48, and each of two ends of the first spring 48 is fixedly connected between the contact for resisting pressure 46 and the movement frame 22.

One end of the rod 47 away from the contact for resisting pressure 46 is fixedly connected with a bearing plate 49. Surface of the bearing plate 49 is provided with three fixing rings 418. The bearing plate 49 is connected with a push rod 410 via the fixing rings 418, inner side of only one of the three fixing rings 418 on surface of a same bearing plate 49 is installed with the push rod 410, and position of the push rod 410 connected on surface of one bearing plate 49 of the three bearing plates 49 is offset from other two positions of the push rod 410 corresponding to other two bearing plate 49 of the three bearing plates 49.

Interior of the dispensing subassembly 29 is installed with a discharge barrel 41, lower surface of the discharge barrel 41 is connected with a discharge pipe 42, outlet of lower end of the discharge pipe 42 is connected with a feed pipe 43, a fixing column 44 is arranged between the feed pipe 43 and the fixing plate 23, one end of the fixing column 44 is fixedly connected to the fixing plate 23, and another end of the fixing column 44 is fixedly connected to the feed pipe 43.

Inner side of the discharge pipe 42 is provided with three baiting grooves 412 and one active groove 413. The push rod 410 passes through surface of the discharge pipe 42 and is fixedly connected to a rubber block 411 inside the discharge pipe 42. The surface of the discharge pipe 42 is provided with a connected groove 419 adapted to the rubber block 411, the rubber block 411 is connected to the discharge pipe 42 in a sliding manner via the connected groove 419, inner side of the active groove 413 is provided with a positioning column 416. Surface of the positioning column 416 is connected with a push ring 414 in a sliding manner, and the surface of the positioning column 416 is wound with a second spring 415. One end of the second spring 415 is fixedly connected to the push ring 414, and another end of the second spring 415 is fixedly connected to the discharge pipe 42. Surface of the rubber block 411 is provided with a positioning groove 417 adapted to the positioning column 416.

The working principle and usage process of the present disclosure are as follows. After the first outputting electric machine 33 is started, the output shaft of the first outputting electric machine 33 drives the first synchronizing wheel 34 to rotate. Due to the fixed connection between the first synchronizing wheel 34 and the rotation member 32, the rotation member 32 will rotate together with the first synchronizing wheel 34. The lower end of the rotation member 32 is connected to the connection rod 31 via a rotation connection manner, so that the connection rod 31 can maintain relative flexible rotation while following the rotation. The rotation of the connection rod 31 then drives the electric telescopic rod 35 and the stirring rod 36 and the stirring member 37 arranged at the end of the electric telescopic rod 35 to perform a circular motion, realizing the stirring operation of the cellulose solution in the dissolving canister 11. Through stirring, cellulose can be more evenly dispersed in the dissolving agents, increasing the contact area between cellulose and dissolving agents, thereby helping improving the solubility of cellulose. The connection rod 31 passes through the circular rings provided on the surfaces of two position-limiting plates 311, and two curved surface blocks 314 are symmetrically and fixedly connected to the connection rod 31 between the two position-limiting plates 311, and each of the two curved surface blocks 314 is matched with a ring arranged at each of the two position-limiting plates 311. This structure ensures the stability of the connection rod 31 during a rotation process, preventing excessive displacement or shaking of the connection rod 31. And each of the surfaces of the two position-limiting plates 311 is fixedly connected with a connection frame 312, and the central position of the transmission rod 310 rotatably connected to the connection frame 312 is fixedly connected with a transmission gear 313, and the outputting gear 315 arranged on the connection rod 31 is meshed with the transmission gear 313. When the rotation member 32 rotates, due to connection between the first synchronizing wheel 34 and the second synchronizing wheel 38 through the synchronizing belt 39, the second synchronizing wheel 38 is caused to rotate accordingly. Rotation of the second synchronizing wheel 38 will drive rotation of the transmission rod 310, and rotation of the transmission rod 310 is transmitted through meshing of the outputting gear 315 and the transmission gear 313, forming an auxiliary transmission system, further ensuring the stability and continuity of the stirring action, such that the stirring power can be more evenly transmitted to the stirring rod 36 and other components, so that the stirring rod 36 rotates while revolving, allowing cellulose to be fully dissolved. After the second outputting electric machine 26 is started, the output end of the second outputting electric machine 26 drives the lead screw 25 to rotate. Due to the threaded connection between the lead screw 25 and the L-shaped installing block 317, and the sliding connection between the L-shaped installing block 317 and the movement frame 22 through the movement groove 24, and the sliding connection between the L-shaped installing block 317 and the guide rod 28 arranged on the inner side of the movement groove 24, a guide role is played. When the lead screw 25 rotates, the L-shaped installing block 317 will move horizontally along the movement groove 24. In this way, the horizontal position of the stirring assembly 3 above the dissolving canister 11 can be adjusted as needed to achieve more comprehensive and effective stirring of cellulose solutions in different areas of the dissolving canister 11. When the L-shaped installing block 317 moves on the movement frame 22, the block for resisting pressure 27 fixed on the surface of the L-shaped installing block 317 will move with the movement of the L-shaped installing block 317. When the block for resisting pressure 27 moves to contact the contact for resisting pressure 46 arranged at one end of the rod 47, the block for resisting pressure 27 will apply pressure to the contact for resisting pressure 46. The rod 47 is connected to the movement frame 22 in a sliding manner through the slot 45, and the surface of the rod 47 is wound with the first spring 48. Under the pressure of the block for resisting pressure 27, the rod 47 will slide inward along the slot 45, compressing the first spring 48. One end of each rod 47 away from the contact for resisting pressure 46 is fixedly connected with a bearing plate 49. The push rod 410 is connected on the bearing plate 49 through the fixing ring 418. When the rod 47 slides inward, the rod 47 will drive the bearing plate 49 and the push rod 410 to move together. The push rod 410 passes through the surface of the discharge pipe 42 and is fixedly connected to the rubber block 411 arranged inside the discharge pipe 42. When the push rod 410 moves, the push rod 410 will push the rubber block 411 to move inside the discharge pipe 42. Three baiting grooves 412 and one active groove 413 are arranged on the inner side of the discharge pipe 42. The rubber block 411 is fixedly connected to the discharge pipe 42 through the connected groove 419, and the surface of the rubber block 411 is provided with the positioning groove 417 that is compatible with the positioning column 416. When the rubber block 411 is pushed by the push rod 410, the position of the rubber block 411 inside the discharge pipe 42 will be changed, thereby controlling the communication or closed state of the baiting grooves 412. For example, when the rubber block 411 moves to connect the baiting groove 412 and the outlet of the discharge pipe 42, the dissolving agent in the discharge barrel 41 can be transported to the dissolving canister 11 through the discharge pipe 42, the baiting groove 412, and the feed pipe 43, etc., to achieve a quantitative feeding operation of the material. And the push ring 414 arranged inside the active groove 413 and the second spring 415 wound on the surface of the positioning column 416 can play a reset role after the rubber block 411 moves, so that the rubber block 411 can return to its initial position for the next feeding operation. Through the linkage of the above structures, when there is too much cellulose, the position of the stirring rod 36 can be moved to increase the amount of added dissolving agent.

Finally, it should be noted that the above description is only a preferred embodiment of the present disclosure and is not intended to limit the present disclosure. Although the present disclosure has been described in detail with reference to the aforementioned embodiments, those skilled in the art can still modify the technical solutions described in the aforementioned embodiments or equivalently replace some technical features in the technical solutions. Any modifications, equivalent substitutions, improvements, etc. made within the spirit and principles of the present disclosure shall be included within the scope of protection of the present disclosure.

What is claimed is:

1. A device for dissolving cellulose with high speed and solubility, comprising:
a baseplate (1) and a dissolving canister (11) arranged on surface of the baseplate (1), wherein bottom surface of the dissolving canister (11) is fixedly connected to a supporting column (12), and surface of the dissolving canister (11) is installed with a liquid-discharge pipe (13);
a stirring assembly (3) arranged above the dissolving canister (11), wherein the stirring assembly (3) comprises:
an L-shaped installing block (317) arranged above the dissolving canister (11), wherein a surface of the L-shaped installing block (317) is fixedly connected with a connection block (316), and a surface of the connection block (316) is fixedly connected with a dispensing canister (318); wherein a lower end of the dispensing canister (318) is rotatably connected with a first synchronizing wheel (34); wherein one side of the first synchronizing wheel (34) away from the dispensing canister (318) is fixedly connected with a rotation member (32); a lower end of the rotation member (32) is rotatably connected with a connection rod (31); a lower end of the connection rod (31) is fixedly connected with an electric telescopic rod (35); an end of an extension shaft of the electric telescopic rod (35) is fixedly connected with a stirring rod (36); and a lower end of the stirring rod (36) is fixedly connected with a stirring member (37);
wherein the device further comprises a movement assembly (2) arranged on the surface of the baseplate (1), wherein the movement assembly (2) comprises a vertical plate (21) fixedly connected on the surface of the baseplate (1), wherein an upper end of the vertical plate (21) is fixedly connected with a movement frame (22), and wherein a surface of the movement frame (22) is provided with a movement groove (24);
wherein an upper surface of the L-shaped installing block (317) is fixedly connected with a block for resisting pressure (27), an upper surface of the movement frame (22) is fixedly connected with a dispensing subassembly (29), and a second surface of the movement frame (22) is fixedly connected with a fixing plate (23);
wherein the alliquotting subassembly further comprises a feed assembly (4) arranged on the movement frame (22), wherein the feed assembly (4) comprises three slots (45) provided on a surface of the movement frame (22); the three slots (45) each are connected with the movement groove (45); and inner side of each of the three slots (45) is provided with a rod (47);
wherein the rod (47) is connected to the movement frame (22) in a sliding manner via the slot (45) one end of the rod (47) is fixedly connected with a contact for resisting pressure (46) adapted to the block for resisting pressure (27), a surface of the rod (47) is wound with a first spring (48), and each of two ends of the first spring (48) is fixedly connected between the contact for resisting pressure (46) and the movement frame (22);
wherein one end of the rod (47) away from the contact for resisting pressure (46) is fixedly connected with a bearing plate (49); a surface of the bearing plate (49) is provided with three fixing rings (418); the bearing plate (49) is connected with a push rod (410) via the fixing rings (418); inner side of only one of the three fixing rings (418) on surface of a same bearing plate (49) is installed with the push rod (410); and a position of the push rod (410) connected on surface of one bearing plate (49) of the three bearing plates (49) is offset from two other positions of the push rod (410) corresponding to two other bearing plates (49) of the three bearing plates (49);
wherein an interior of the dispensing subassembly (29) is installed with a discharge barrel (41); a lower surface of the discharge barrel (41) is connected with a discharge pipe (42); an outlet of a lower end of the discharge pipe (42) is connected with a feed pipe (43); a fixing column (44) is arranged between the feed pipe (43) and the fixing plate (23); one end of the fixing column (44) is fixedly connected to the fixing plate (23); and another end of the fixing column (44) is fixedly connected to the feed pipe (43);
wherein an inner side of the discharge pipe (42) is provided with three baiting grooves (412) and one active groove (413); wherein the push rod (410) passes through surface of the discharge pipe (42) and is fixedly connected to a rubber block (411) inside the discharge pipe (42); wherein the surface of the discharge pipe (42) is provided with a connected groove (419) adapted to the rubber block (411); the rubber block (411) is connected to the discharge pipe (42) in a sliding manner via the connected groove (419); an inner side of the active groove (413) is provided with a positioning column (416); a surface of the positioning column (416) is connected with a push ring (414) in a sliding manner; and wherein the surface of the positioning column (416) is wound with a second spring (415); one end of the second spring (415) is fixedly connected to the push ring (414); and another end of the second spring (415) is fixedly connected to the discharge pipe (42); and wherein a surface of the rubber block (411) is provided with a positioning groove (417) adapted to the positioning column (416).

2. The device for dissolving cellulose with high speed and solubility according to claim 1, wherein the surface of the connection block (316) is installed with a first outputting electric machine (33); wherein an output shaft of the first outputting electric machine (33) passes through a positioning canister (318) and is fixedly connected to the first synchronizing wheel (34).

3. The device for dissolving cellulose with high speed and solubility according to claim 2, wherein two position-limiting plates (311) are symmetrically arranged below the connection block (316), wherein the connection rod (31) passes through rings provided on a surface of each of the two position-limiting plates (311); two curved surface blocks (314) are symmetrically and fixedly connected to a position of the connection rod (31) between the two position-limiting plates (311); and each of the two curved surface blocks (314) is matched with one of the rings of the two position-limiting plates (311).

4. The device for dissolving cellulose with high speed and solubility according to claim 3, wherein a surface of each of the two position-limiting plates (311) is fixedly connected with a connection frame (312); wherein a surface of the connection frame (312) is rotatably connected with a transmission rod (310); a transmission gear (313) is fixedly connected to a position of the transmission rod (310) between two connection frames (312); an outputting gear (315) is arranged between the two curved surface blocks (314); the outputting gear (315) is fixedly connected on surface of the connection rod (31); the transmission gear (313) is meshed with the outputting gear (315); an upper end of the transmission rod (310) is fixedly connected with a second synchronizing wheel (38); and the first synchronizing wheel (34) and the second synchronizing wheel (38) are connected via a synchronizing belt (39).

5. The device for dissolving cellulose with high speed and solubility according to claim 4, wherein the L-shaped installing block (317) is connected to the movement frame (22) in a sliding manner via the movement groove (24); the upper surface of the movement frame (22) is installed with a second outputting electric machine (26); an output end of the second outputting electric machine (26) is fixedly connected with a lead screw (25); wherein the lead screw (25) passes through the movement frame (22) and is rotatably connected to the movement frame (22); and wherein the lead screw (25) is connected to the L-shaped installing block (317) via threads; an inner side of the movement groove (24) is provided with a guide rod (28); and the guide rod (28) is connected to the L-shaped installing block (317) via a sliding manner.
